(19) United States
(12) Patent Application Publication
(10) Pub. No.: US 2026/0130548 A1
(43) Pub. Date: May 14, 2026

(54) Flush Wand Device

(71) Applicant: Carl Nichols, Visalia, CA (US)

(72) Inventor: Carl Nichols, Visalia, CA (US)

(21) Appl. No.: 19/011,711

(22) Filed: Jan. 7, 2025

Related U.S. Application Data
(60) Provisional application No. 63/719,143, filed on Nov. 12, 2024.

(51) Int. Cl. A47K 17/00; B08B 1/10; B08B 9/00

(52) U.S. Cl. CPC A47K 17/00; B08B 1/10; B08B 9/00

(57) ABSTRACT

A flushable toilet wand device is disclosed, which is a flushable cleaning device for toilets. The flushable toilet wand device comprises a base component that is configured in a cylindrical elongated shape with a hollow interior. A scented sodium bicarbonate core is positioned within the hollow interior for cleaning the toilet bowl. The base component is typically comprised of a stiff paper construction. Typically, the base component is approximately 12 inches in length and has a three-inch perforated end which breaks off after cleaning. The perforated segment is then dropped directly into the toilet bowl for extra cleaning.

### CROSS-REFERENCE TO RELATED APPLICATION

The present application claims priority to, and the benefit of, U.S. Provisional Application No. 63/719,143, which was filed on Nov. 12, 2024, and is incorporated herein by reference in its entirety.

### FIELD OF THE INVENTION

The present invention relates generally to the field of flushable toilet wand devices. More specifically, the present invention relates to a flushable cleaning device for toilets with a built-in bicarbonate core. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in flushable toilet wand devices. Generally, toilet cleaning is oftentimes accomplished with brushes that have plastic handles and bristles. The brushes are reusable but create an unsightly and unsanitary condition sitting in the bathroom after each use.

Cleaning a toilet bowl is one of the most undesirable household chores for most people. This is because toilets are contaminated by various organic materials that contain or support growth of microorganisms. Toilet bowls must be kept clean to prevent harmful bacteria buildup, irritable smells and potentially unsanitary conditions.

Toilets are most commonly cleaned with brushes that have bristles permanently affixed to a handle. While effective in their primary task of cleaning toilet bowls, such brushes have serious drawbacks related to their storage between uses. Regardless of how much care is taken to clean the bristles following use, there often remain small quantities of feces, urine and stray bits of paper typically found in a toilet. These can cause brushes to develop an unpleasant odor and make the brushes undesirable for storage in proximity to the toilet.

Further, once the bowl has been cleaned, the individual cleaning the bowl will oftentimes simply carry the cleaning tool, together with any germs which may be on the tool, to another location where further cleaning is to be done. It is believed that this process inherently leads to the transportation of germs, via the cleaning tool, from the first cleaning site to subsequent cleaning sites as the cleaning tool is taken from location to location. Generally, such brushes are not discarded after use but are stored in bathrooms near or behind toilet bowls. There exists a need for a cleaning tool which inhibits, if not restricts, the transportation of germs from one cleaning site to another.

Accordingly, there is a demand for an improved flushable toilet wand device that provides a flushable cleaning device for toilets with a built-in bicarbonate core. More particularly, there is a demand for a flushable toilet wand device that cleans a toilet while leaving a fresh fizzy effect.

Therefore, there exists a long felt need in the art for a flushable toilet wand device that provides users with a flushable cleaning device for toilets. There is also a long felt need in the art for a flushable toilet wand device that includes a bicarbonate core. Further, there is a long felt need in the art for a flushable toilet wand device that comprises a relatively stiff paper construction around the bicarbonate core. Moreover, there is a long felt need in the art for a device that includes perforated sections which easily break off and flush after scrubbing the toilet. Further, there is a long felt need in the art for a flushable toilet wand device that leaves a fresh fizzy effect after cleaning. Finally, there is a long felt need in the art for a flushable toilet want device that is approximately 12 inches long.

The subject matter disclosed and claimed herein, in one embodiment thereof, comprises a flushable toilet wand device. The device is a flushable cleaning device for toilets. The flushable toilet wand device comprises a base component that is configured in a cylindrical elongated shape with a hollow interior. A scented sodium bicarbonate core is positioned within the hollow interior for cleaning the toilet bowl. The base component is typically comprised of a stiff paper construction. Typically, the base component is approximately 12 inches in length and has a three-inch perforation at its end which breaks off after cleaning. The three-inch perforated segment is disposed directly into the toilet bowl for extra cleaning.

In this manner, the flushable toilet wand device of the present invention accomplishes all of the forgoing objectives and provides users with a flushable cleaning device for toilets. The device is an elongated base component with a bicarbonate core. The device leaves a fresh fizzy effect while cleaning.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flushable toilet wand device. The device is a flushable cleaning device for toilets. The flushable toilet wand device comprises a base component with a sodium bicarbonate core. The base component is typically comprised of a stiff paper construction which is flushable after use.

In one embodiment, the flushable toilet wand device is utilized to easily clean toilet bowls and other highly soiled surfaces. The device allows a user to replace a dirty, germ-laden cleaning tool from a bathroom with the flushable toilet wand device. The device minimizes the unsanitary transmission of any germs which may be residing on the previous cleaning tool.

In one embodiment, the flushable toilet wand device is a cleaning tool which is useable to effect a cleaning operation of a specified physical environment, such as a toilet bowl. The flushable toilet wand device comprises a base component that is configured in a cylindrical elongated shape with a hollow interior. The base component comprises an exterior surface and a proximal end (i.e., a handle end) and a distal end (i.e., a cleaning tip). The base component is typically fabricated, either in whole or in part, from a stiff paper construction, such as rolled toilet paper with a dissolvable binding agent to create stiffness, or other suitable water-soluble materials, such as cornstarch, wheat paste of the type that is conventionally used in the manufacture of “packaging peanuts.” Specifically, the stiff paper construction offers better scrubbing power, then softens for better bowl wiping, without compromising flushability. Thus, the base component easily removes streaks, splatters, and fecal residue within a toilet bowl. By manipulating the fabricating material, the material becomes subject to breaking down in the presence of moisture. Being subject to breaking down, the material is suitable for fabricating a device which may be deposited into the toilet bowl after use and subsequently flushed away.

In one embodiment, the base component is approximately 12 inches in length but can be any suitable length as is known in the art and has approximately a ¼ inch diameter, as long as the base component is of sufficient length and sturdiness to effectively clean a toilet bowl. Further, the base component can be any suitable shape and size as is known in the art, depending on the needs and/or wants of a user. After a user grasps the proximal end or handle of the base component, the distal end or cleaning tip is disposed directly into the toilet bowl and used to clean the interior of the toilet bowl. As the cleaning operation is being completed, the distal end of the base component is placed into contact with a quantity of liquid, such as water within the toilet bowl. The base component, being fabricated from a water-soluble material, decomposes upon being brought into contact with the liquid. Accordingly, after cleaning of the toilet bowl is completed, the user simply deposits the base component in the toilet bowl and flushes. The water in the toilet bowl then causes the base component to decompose sufficiently that the device, together with any germs residing thereon, may be discharged to the conventional sewer system interconnected to the toilet by simply flushing the toilet. Thus, the flushable toilet wand device is a disposable, one-use device for cleaning toilets and other suitable services.

In one embodiment, the base component comprises a sodium bicarbonate core, which acts as a cleaning agent. The sodium bicarbonate core extends the length of the base component from end to end. The sodium bicarbonate core aids in cleaning and disinfecting the toilet bowl or other suitable surface. The sodium bicarbonate core produces a fresh, fizzy effect while cleaning the toilet bowl. The sodium bicarbonate core can be a blue sodium bicarbonate core that offers extra scrubbing power and works like a toilet tab as it is flushed, leaving a fresh impression after cleaning. In one embodiment, the sodium bicarbonate core is scented with different scents, depending on the needs and/or wants of a user. Thus, after use, the scented sodium bicarbonate core leaves the toilet bowl with a fresh scent after cleaning.

In one embodiment, the base component comprises an approximately three-inch perforated segment on the proximal end (handle end). The perforation is positioned approximately three inches from the proximal end of the base component and extends around the circumference of the base component. The perforation allows a user to easily snap off the three-inch perforated segment. Specifically, the three-inch perforated segment is configured to break off after cleaning. Typically, a user would use the three-inch perforated segment as a handle while cleaning the toilet bowl. The user would then snap off the three-inch perforated segment from the proximal end of the base component. Once removed, the user can flush the remaining base component down the toilet. The user can then drop the three-inch perforated segment into the toilet bowl after flushing to leave a clean, scented impression with blue water for extra cleaning. Thus, the entire base component and sodium bicarbonate core (minus the three-inch perforated segment) would dissolve shortly after use into a condition where the device could be flushed.

In one embodiment, the flushable toilet wand device, together with any germs residing thereon soon dissolves within the toilet bowl during cleaning, so that the remains of the device together with the germs can be flushed away. By not removing the flushable toilet wand device from the cleaning site, the device together with the unhealthy environment of germs associated with the storage of a used toilet brush is eliminated. The unpleasantness and health risk of such practice may be of particular interest to parents of infant and toddler children who often are in close proximity to such a toilet brush while in the bathroom.

In yet another embodiment, the flushable toilet wand device comprises a plurality of indicia.

In yet another embodiment, a method of easily cleaning a toilet with a flushable device is disclosed. The method includes the steps of providing a flushable toilet wand device comprising a base component with a bicarbonate core. The method also comprises positioning the cleaning tip end of the base component into a toilet bowl. Further, the method comprises scrubbing the interior of the toilet bowl with the stiff paper construction of the base component and the bicarbonate core. The method also comprises breaking off the perforated tip of the base component and flushing the rest of the base component into the toilet bowl. Finally, the method comprises dropping the perforated tip into the toilet bowl for extra cleaning.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a perspective view of one embodiment of the flushable toilet wand device of the present invention in accordance with the disclosed architecture;

FIG. 2 illustrates a perspective view of one embodiment of the flushable toilet wand device of the present invention showing the elongated base component in accordance with the disclosed architecture;

FIG. 3 illustrates a perspective view of one embodiment of the flushable toilet wand device of the present invention showing the perforated tip in accordance with the disclosed architecture;

FIG. 4 illustrates a perspective view of one embodiment of the flushable toilet wand device of the present invention showing the bicarbonate core in accordance with the disclosed architecture;

FIG. 5 illustrates a perspective view of one embodiment of the flushable toilet wand device of the present invention showing the bicarbonate core exposed from the base component in accordance with the disclosed architecture;

FIG. 6 illustrates a perspective view of one embodiment of the flushable toilet wand device of the present invention showing the device in use in accordance with the disclosed architecture;

FIGS. 7A-D illustrate a perspective view of one embodiment of the flushable toilet wand device of the present invention showing the device and its components in accordance with the disclosed architecture;

FIGS. 8A-C illustrate a perspective view of one embodiment of the flushable toilet wand device of the present invention in accordance with the disclosed architecture; and

FIG. 9 illustrates a flowchart showing the method of easily cleaning a toilet with a flushable device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a flushable toilet wand device that provides users with a flushable cleaning device for toilets. There is also a long felt need in the art for a flushable toilet wand device that includes a bicarbonate core. Further, there is a long felt need in the art for a flushable toilet wand device that comprises a relatively stiff paper construction around the bicarbonate core. Moreover, there is a long felt need in the art for a device that includes perforated sections which easily break off and flush after scrubbing the toilet. Further, there is a long felt need in the art for a flushable toilet wand device that leaves a fresh fizzy effect after cleaning. Finally, there is a long felt need in the art for a flushable toilet want device that is approximately 12 inches long.

The present invention, in one exemplary embodiment, is a novel flushable toilet wand device. The flushable toilet wand device comprises a base component that is configured in a cylindrical elongated shape with a hollow interior. A scented sodium bicarbonate core is positioned within the hollow interior for cleaning the toilet bowl. The base component is typically comprised of a stiff paper construction. Typically, the base component is approximately 12 inches in length and has a three-inch perforation at its end which breaks off after cleaning. The perforated end is then disposed directly into the toilet bowl for extra cleaning. The present invention also includes a novel method of easily cleaning a toilet with a flushable device. The method includes the steps of providing a flushable toilet wand device comprising a base component with a bicarbonate core. The method also comprises positioning the cleaning tip end of the base component into a toilet bowl. Further, the method comprises scrubbing the interior of the toilet bowl with the stiff paper construction of the base component and the bicarbonate core. The method also comprises breaking off the perforated tip of the base component and flushing the rest of the base component into the toilet bowl. Finally, the method comprises dropping the perforated tip into the toilet bowl for extra cleaning.

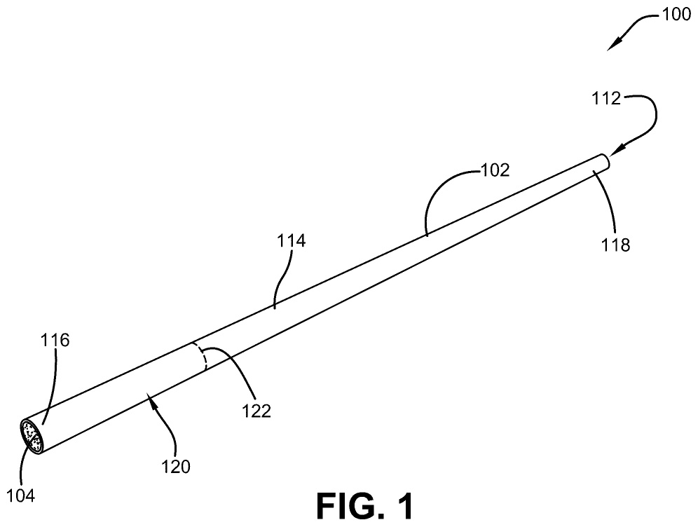

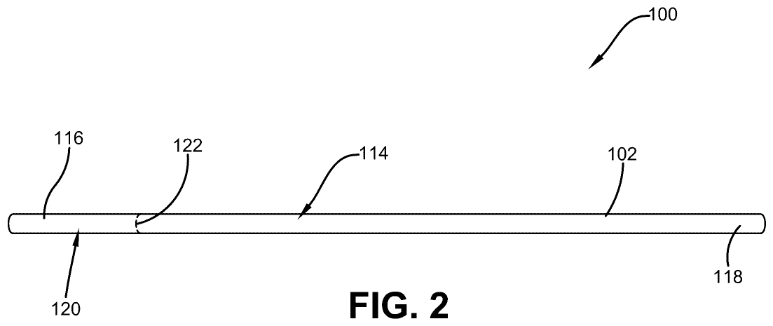

Referring initially to the drawings, FIGS. 1-2 illustrate a perspective view of one embodiment of the flushable toilet wand device 100 of the present invention. In the present embodiment, the flushable toilet wand device 100 is an improved flushable toilet wand device 100 that provides a user 108 with a flushable cleaning device for toilets 106. Specifically, the flushable toilet wand device 100 comprises a base component 102 with a sodium bicarbonate core 104. The base component 102 is typically comprised of a stiff paper construction which is flushable after use.

Generally, the flushable toilet wand device 100 is utilized to easily clean toilet bowls 110 and other highly soiled surfaces. The device 100 allows a user 108 to replace a dirty, germ-laden cleaning tool from a bathroom with the flushable toilet wand device 100. The device 100 minimizes the unsanitary transmission of any germs which may be residing on the previous cleaning tool.

Further, the flushable toilet wand device 100 is a cleaning tool which is useable to effect a cleaning operation of a specified physical environment, such as a toilet bowl 110. The flushable toilet wand device 100 comprises a base component 102 that is configured in a cylindrical elongated shape with a hollow interior 112. The base component 102 comprises an exterior surface 114 and a proximal end (i.e., a handle end) 116 and a distal end (i.e., a cleaning tip) 118. The base component 102 is typically fabricated, either in whole or in part, from a stiff paper construction, such as rolled toilet paper with a dissolvable binding agent to create stiffness, or other suitable water-soluble materials, such as cornstarch, wheat paste of the type that is conventionally used in the manufacture of “packaging peanuts.” Specifically, the stiff paper construction offers better scrubbing power, then softens for better bowl wiping, without compromising flushability. Thus, the base component 102 easily removes streaks, splatters, and fecal residue within a toilet bowl 110. By manipulating the fabricating material, the material becomes subject to breaking down in the presence of moisture. Being subject to breaking down, the material is suitable for fabricating a device 100 which may be deposited into the toilet bowl 110 after use and subsequently flushed away.

Additionally, the base component 102 is approximately 12 inches in length but can be any suitable length as is known in the art and has approximately a ¼ inch diameter, as long as the base component 102 is of sufficient length and sturdiness to effectively clean a toilet bowl 110. Further, the base component 102 can be any suitable shape and size as is known in the art, depending on the needs and/or wants of a user 108. After a user 108 grasps the proximal end 116 or handle of the base component 102, the distal end 118 or cleaning tip is disposed directly into the toilet bowl 110 and used to clean the interior of the toilet bowl 110. As the cleaning operation is being completed, the distal end 118 of the base component 102 is placed into contact with a quantity of liquid, such as water within the toilet bowl 110. The base component 102, being fabricated from a water-soluble material, decomposes upon being brought into contact with the liquid. Accordingly, after cleaning of the toilet bowl 110 is completed, the user 108 simply deposits the base component 102 in the toilet bowl 110 and flushes. The water in the toilet bowl 110 then causes the base component 102 to decompose sufficiently that the device 100, together with any germs residing thereon, may be discharged to the conventional sewer system interconnected to the toilet 106 by simply flushing the toilet 106. Thus, the flushable toilet wand device 100 is a disposable, one-use device for cleaning toilets 106 and other suitable services.

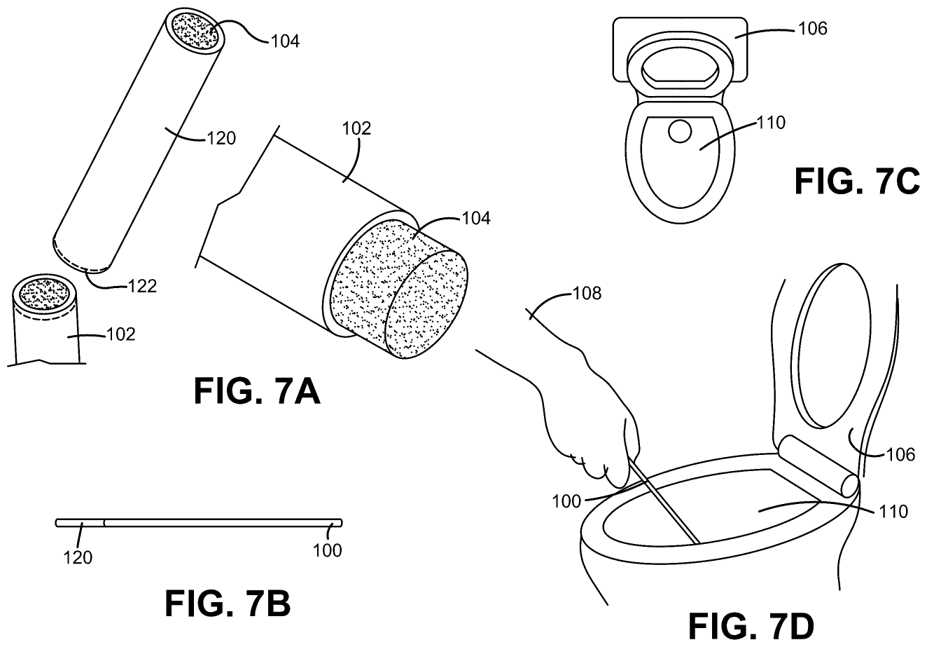

As shown in FIGS. 7A-D and 8A-C, the base component 102 comprises a sodium bicarbonate core 104, which acts as a cleaning agent. The sodium bicarbonate core 104 extends the length of the base component 102 from end 116 to end 118. The sodium bicarbonate core 104 aids in cleaning and disinfecting the toilet bowl 110 or other suitable surface. The sodium bicarbonate core 104 produces a fresh, fizzy effect while cleaning the toilet bowl 110. The sodium bicarbonate core 104 can be a blue sodium bicarbonate core that offers extra scrubbing power and works like a toilet tab as it is flushed, leaving a fresh impression after cleaning. In one embodiment, the sodium bicarbonate core 104 is scented with different scents, depending on the needs and/or wants of a user 108. Thus, after use, the scented sodium bicarbonate core 104 leaves the toilet bowl 110 with a fresh scent after cleaning.

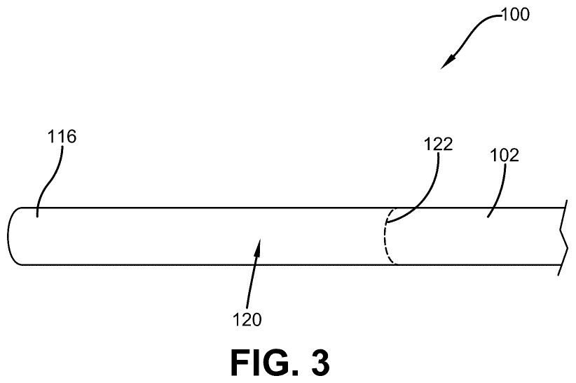

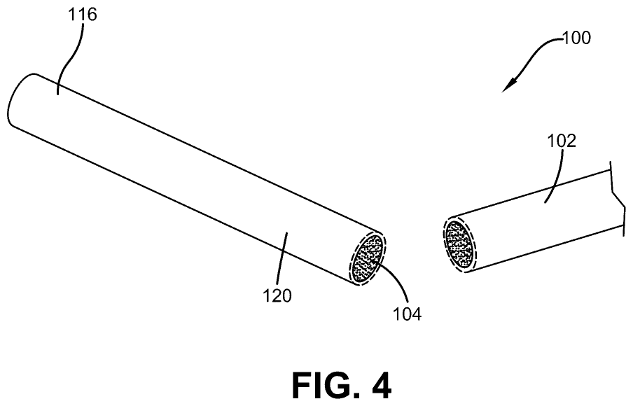

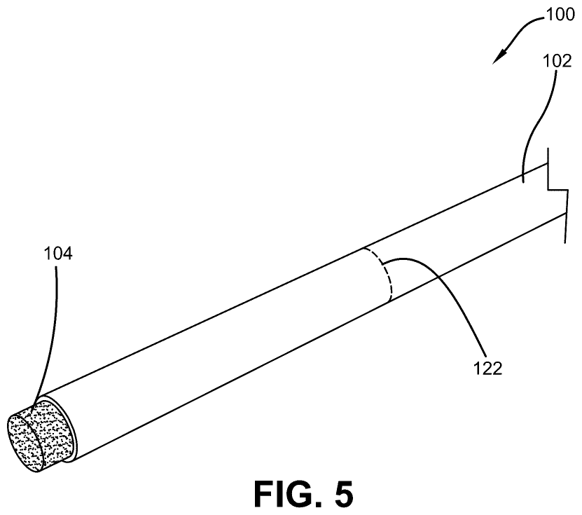

As shown in FIGS. 3-5, the base component 102 comprises an approximately three-inch perforated segment 120 on the proximal end 116 (handle end). The perforation 122 is positioned approximately three inches from the proximal end 116 of the base component 102 and extends around the circumference of the base component 102. The perforation 122 allows a user 108 to easily snap off the three-inch perforated segment 120. Specifically, the three-inch perforated segment 120 is configured to break off after cleaning. Typically, a user 108 would use the three-inch perforated segment 120 as a handle while cleaning the toilet bowl 110. The user 108 would then snap off the three-inch perforated segment 120 from the proximal end 116 of the base component 102. Once removed, the user 108 can flush the remaining base component 102 down the toilet 106. The user 108 can then drop the three-inch perforated segment 120 into the toilet bowl 110 after flushing to leave a clean, scented impression with blue water for extra cleaning. Thus, the entire base component 102 and sodium bicarbonate core 104 (minus the three-inch perforated segment 120) would dissolve shortly after use into a condition where the device 100 could be flushed.

In yet another embodiment, the flushable toilet wand device 100 comprises a plurality of indicia 500. The base component 102 of the device 100 may include advertising, a trademark, or other letters, designs, or characters, printed, painted, stamped, or integrated into the base component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be toilet bowl, toilet wand, or brand related.

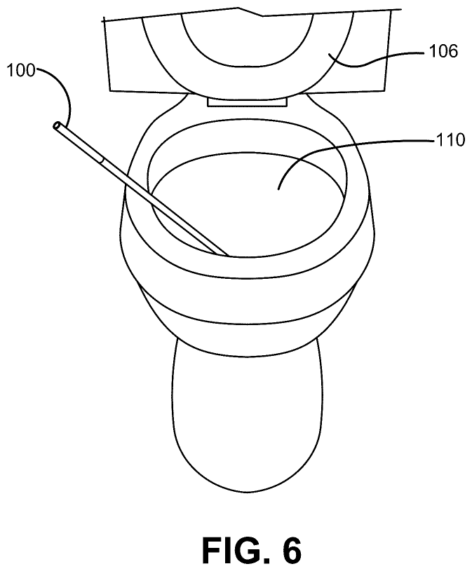

As shown in FIG. 6, the flushable toilet wand device 100, together with any germs residing thereon soon dissolves within the toilet bowl 110 during cleaning, so that the remains of the device 100 together with the germs can be flushed away. By not removing the flushable toilet wand device 100 from the cleaning site, the device 100 together with the unhealthy environment of germs associated with the storage of a used toilet brush is eliminated. The unpleasantness and health risk of such practice may be of particular interest to parents of infant and toddler children who often are in close proximity to such a toilet brush while in the bathroom.

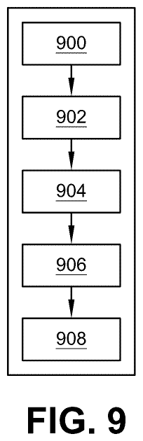

FIG. 9 illustrates a flowchart of the method of easily cleaning a toilet with a flushable device. The method includes the steps of at 900, providing a flushable toilet wand device comprising a base component with a bicarbonate core. The method also comprises at 902, positioning the cleaning tip end of the base component into a toilet bowl. Further, the method comprises at 904, scrubbing the interior of the toilet bowl with the stiff paper construction of the base component and the bicarbonate core. The method also comprises at 906, breaking off the perforated tip of the base component and flushing the rest of the base component into the toilet bowl. Finally, the method comprises at 908, dropping the perforated tip into the toilet bowl for extra cleaning.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “flushable toilet wand device”, “toilet wand device”, “flushable device”, and “device” are interchangeable and refer to the flushable toilet wand device 100 of the present invention.

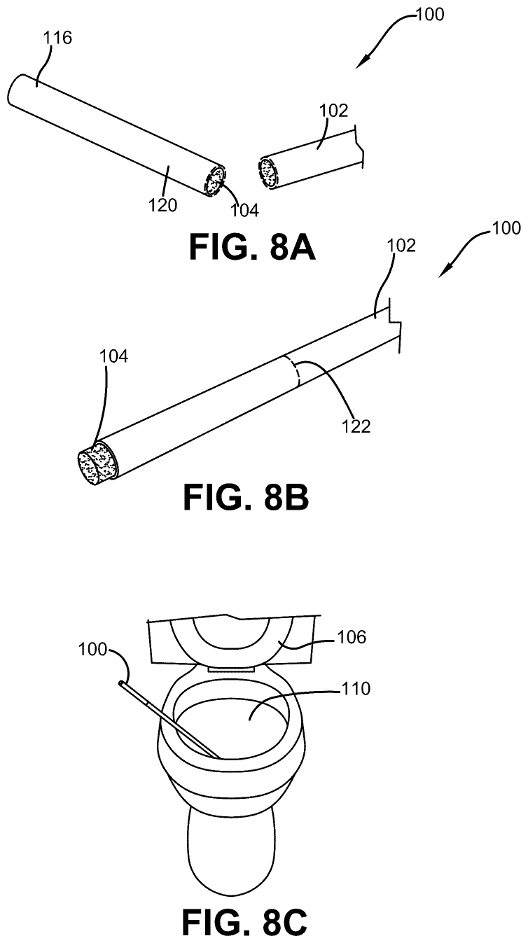

Notwithstanding the forgoing, the flushable toilet wand device 100 of the present invention can be of any suitable size and configuration as is known in the art without affecting the overall concept of the invention, provided that it accomplishes the above stated objectives. One of ordinary skill in the art will appreciate that the flushable toilet wand device 100 as shown in FIGS. 1-9 is for illustrative purposes only, and that many other sizes and shapes of the flushable toilet wand device 100 are well within the scope of the present disclosure. Although the dimensions of the flushable toilet wand device 100 are important design parameters for user convenience, the flushable toilet wand device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flushable toilet wand device that provides a user with a flushable cleaning device for toilets, the flushable toilet wand device comprising:
a base component; and
a sodium bicarbonate core;
wherein the sodium bicarbonate core is positioned within the base component;
wherein the base component with the sodium bicarbonate core is utilized to clean a toilet bowl; and
further wherein the base component with sodium bicarbonate core is flushable after use.

2. The flushable toilet wand device of claim 1, wherein the base component is configured in a cylindrical elongated shape with a hollow interior.

3. The flushable toilet wand device of claim 2, wherein the base component comprises an exterior surface and a proximal end and a distal end.

4. The flushable toilet wand device of claim 3, wherein the base component is fabricated, either in whole or in part, from a stiff paper construction, such as rolled toilet paper with a dissolvable binding agent to create stiffness.

5. The flushable toilet wand device of claim 4, wherein the stiff paper construction offers better scrubbing power, then softens for better toilet bowl wiping, without compromising flushability.

6. The flushable toilet wand device of claim 5, wherein the base component is approximately 12 inches in length and has an approximately ¼ inch diameter.

7. The flushable toilet wand device of claim 6, wherein a user grasps the proximal end of the base component and uses the distal end, which is disposed directly into the toilet bowl, to clean an interior of the toilet bowl, such that the base component decomposes upon being brought into contact with water within the toilet bowl.

8. The flushable toilet wand device of claim 7, wherein the base component is then flushed after use, such that the flushable toilet wand device is a disposable, one-use device.

9. The flushable toilet wand device of claim 8, wherein the sodium bicarbonate core is a blue sodium bicarbonate core.

10. The flushable toilet wand device of claim 9, wherein the sodium bicarbonate core is scented.

11. The flushable toilet wand device of claim 10, wherein the base component comprises a three-inch perforated segment on the proximal end.

12. The flushable toilet wand device of claim 11, wherein a perforation is positioned approximately three inches from the proximal end of the base component and extends around a circumference of the base component.

13. The flushable toilet wand device of claim 12, wherein the perforation allows a user to easily snap off the three-inch perforated segment.

14. A flushable toilet wand device that provides a user with a flushable cleaning device for toilets, the flushable toilet wand device comprising:
a base component configured in a cylindrical elongated shape with a hollow interior, an exterior surface and a proximal end and a distal end;
a sodium bicarbonate core positioned within the hollow interior of the base component; and
a three-inch perforated segment which is a perforation positioned approximately three inches from the proximal end of the base component;
wherein the base component is fabricated, either in whole or in part, from a stiff paper construction, such as rolled toilet paper with a dissolvable binding agent to create stiffness;
wherein the base component with the sodium bicarbonate core is utilized to clean a toilet bowl;
wherein the stiff paper construction offers better scrubbing power, then softens for better toilet bowl wiping, without compromising flushability;
wherein a user grasps the proximal end of the base component and uses the distal end, which is disposed directly into the toilet bowl, to clean an interior of the toilet bowl, such that the base component decomposes upon being brought into contact with water within the toilet bowl;
wherein the base component with sodium bicarbonate core is flushable after use; and
further wherein the perforation allows a user to easily snap off the three-inch perforated segment.

15. The flushable toilet wand device of claim 14, wherein a user would use the three-inch perforated segment as a handle while cleaning the toilet bowl.

16. The flushable toilet wand device of claim 15, wherein after cleaning, the user would then snap off the three-inch perforated segment from the proximal end of the base component.

17. The flushable toilet wand device of claim 16, wherein once removed, the user flushes remaining base component down the toilet bowl.

18. The flushable toilet wand device of claim 17, wherein the user then drops the three-inch perforated segment into the toilet bowl after flushing to leave a clean, scented toilet bowl with blue water for extra cleaning.

19. The flushable toilet wand device of claim 14 further comprising a plurality of indicia.

20. A method of easily cleaning a toilet with a flushable device, the method comprising the following steps:
providing a flushable toilet wand device comprising a base component with a bicarbonate core;
positioning the cleaning tip end of the base component into a toilet bowl;
scrubbing the interior of the toilet bowl with the stiff paper construction of the base component and the bicarbonate core;
breaking off the perforated tip of the base component and flushing the rest of the base component into the toilet bowl; and
dropping the perforated tip into the toilet bowl for extra cleaning.
